(19) United States
(12) Patent Application Publication
(10) Pub. No.: US 2005/0245271 A1
(43) Pub. Date: Nov. 3, 2005

(54) System and method using location-aware devices to provide content-rich mobile services in a wireless network

(76) Inventor: Sarosh Vesuna, Los Altos, CA (US)

Correspondence Address: BAKER & BOTTS, 30 ROCKEFELLER PLAZA, NEW YORK, NY, 10112, US

(21) Appl. No.: 10/834,747

(22) Filed: Apr. 28, 2004

(51) Int. Cl. H04Q 7/20

(52) U.S. Cl. 455/456.1

(57) ABSTRACT

A system and method is provided for providing enriched content over a wireless network to a mobile device based on location information read by the mobile device from a location information storage device. The location information storage device may be a bar code, RFID tag, Infobutton, or any other device which may be affixed to a fixed location and which may store unique location information to be read by the mobile device.

### BACKGROUND OF THE INVENTION

The present invention relates to systems and methods for combining location-aware barcodes, RFID tags, or Infobuttons, with wireless network functionality to provide content-rich mobile commerce services.

Wireless Local Area Networks (LANs) and Wide Area Networks (WANs) are rolled out with increased geographic coverage as these technologies develop. Wireless LAN “Hot Spots” are becoming increasingly common in public places such as parks and cafes, while wireless WAN networks are implemented in expanding geographic regions for use with laptops and cellular phones. Additionally, as the technology progresses, bandwidth continues to increase to allow higher data dates with more reliability than was available with previous generation wireless LANs and WANs.

As a mobile device user navigates various different types of available wireless networks, the move device is generally unaware of its present location unless some system is put in place which provides this information. Some cellular information carriers, for example, provide GPS (Global Positioning Systems) services for emergency response such that the location of the cellular phone or mobile device may be ascertained. However, a GPS system can be costly to implement in small or medium scales, and may not provide the accuracy required for certain localized applications. Additionally, such a system cannot provide local information directly to the mobile device, which information may be useful in conjunction with information obtained over the wireless network.

It would be advantageous to provide a system and method for utilizing these emerging wireless network technologies in various applications to provide enriched location-based content to users of mobile wireless devices. Accordingly, it is an object of the present invention to provide a system and method for relating geographic location information with a location-aware device to provide enriched content to a mobile terminal.

### SUMMARY OF THE INVENTION

In accordance with the invention there is provided a method for providing location-based information over a wireless network, including the steps of providing at a geographic location a machine-readable coded identification item to provide data for uniquely identifying the geographic location, providing a first database correlating the data to the geographic location, providing a second database having information correlated to the geographic location, reading the identification item with a portable reader to obtain the identification data, using the first database to ascertain the geographic location, and using the second database to retrieve information correlated to the geographic location.

In accordance with the invention there is provided a system for providing location-based information, which system includes a wireless network, a machine-readable coded identification item for storing location data, a mobile device, which mobile device includes at least a processor, a memory, a wireless radio configured to communicate on said wireless network, and a reader capable of reading data from said machine-readable coded identification item, wherein the mobile device is configured to read data from the machine-readable coded identification item and transmit the data over the wireless network and receive from the wireless network information relating to the location of the machine-readable coded identification item.

In accordance with the invention there is further provided a method for providing location-based information over a wireless network, including the steps of providing at a geographic location a machine-readable coded identification item providing data for uniquely identifying the geographic location, and reading said identification item with a portable reader to obtain information regarding said geographic location.

In accordance with the invention there is further provided a system for providing location-based information, including a wireless network, a machine-readable coded identification item storing data related to the location of the machine-readable coded identification item, and a mobile device, which mobile device includes at least a processor, a memory, a wireless radio configured to communicate on the wireless network, and a reader capable of reading data from the machine-readable coded identification item, wherein the mobile device is configured to read the data from the machine-readable coded identification item to obtain information regarding the location of the mobile device.

In accordance with the invention there is further provided a method for providing location-based information over a wireless network including the steps of providing at a geographic location a machine-readable coded identification item providing data for uniquely identifying the geographic location, providing a database correlating the data to information relating to the geographic location, reading the identification item with a portable reader to obtain the identification data, and providing the information relating to the geographic location to the portable reader.

For a better understanding of the present invention, together with other and further objects, reference is made to the following description, taken in conjunction with the accompanying drawings, and its scope will be pointed out in the appended claims.

### BRIEF DESCRIPTION OF THE DRAWING

FIG. 1 is a block diagram of an exemplary wireless local area network and location identification apparatus which may be used in conjunction with the present invention;

FIG. 2 is a block diagram of an exemplary mobile unit according to the present invention;

FIG. 3 is an illustration of an exemplary system and method according to the present invention in operation.

Throughout the figures, unless otherwise stated, the same reference numerals and characters are used to denote like features, elements, components, or portions of the illustrated embodiments.

### DETAILED DESCRIPTION OF THE INVENTION

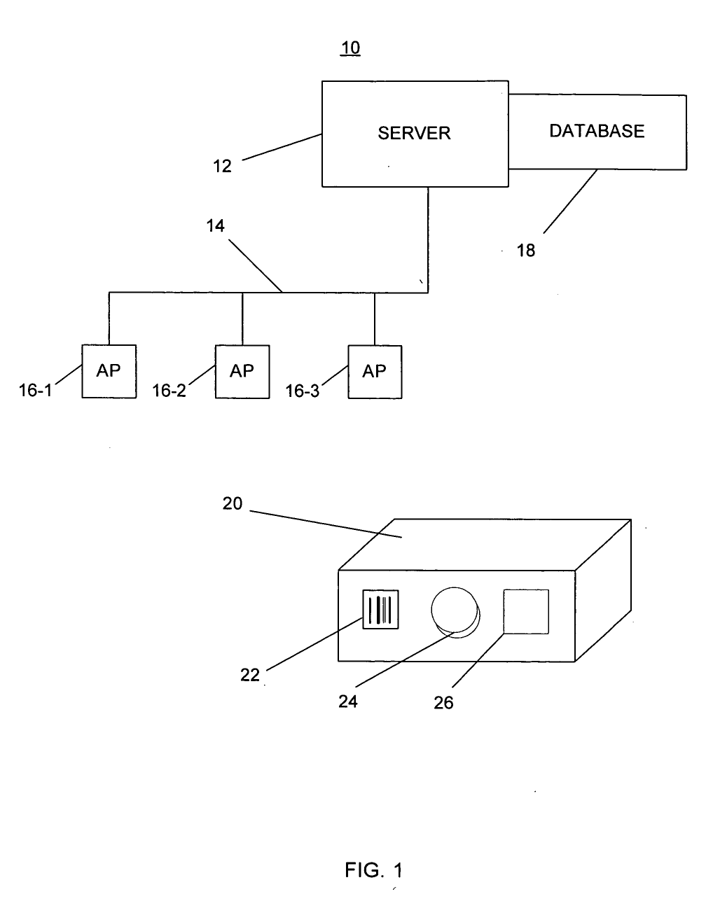

Referring to FIG. 1, an exemplary wireless network 10 is shown, which may preferably comprise, for example, a network in a public location for providing content-rich mobile services to mobile device users. Wireless network 10 may preferably be a Wireless WAN or alternatively may be a Wireless LAN, depending upon the particular requirements and implementation of the embodiment of the present invention. In a preferred embodiment, the wireless wide area network may operate according to a standard protocol such as GPRS, or the wireless local area network may operate according to a standard protocol such as IEEE standard 802.11 protocol or Bluetooth protocol. It is noted that the present invention is not limited to these exemplary types of wireless networks—the present invention may be implemented in any type of wireless network.

Wireless network 10 perferably includes a server computer 12 coupled to a plurality of access points (“AP”) 16. These access points may preferably be wireless access points as would normally be implemented in accordance with the selected wireless network type. In an exemplary embodiment of the present invention utilizing a GPRS wireless WAN, APs 16 may be cellular communications towers operating in the downtown area of a city. The access points 14 may be coupled to a server computer 12 by a link 14 which may be a standard Ethernet network cable, T-1, ISDN, Internet, or any other means for bi-directional data transmission.

Server computer 12 of the exemplary embodiment of the present invention described in FIG. 1 is also preferably coupled to a database 18. Database 18 is preferably used to store one or more database tables which comprise information respecting various locations, as will be discussed further hereinafter.

In the exemplary embodiment of the present invention, infrastructure 20 may preferably be any fixed element in a public area upon which a location information device may be affixed, such as a bus stop shelters, signposts, lampposts, mall directories, kiosks, hotels, convention centers, museums, grocery stores and other storefronts.

Also in accordance with an exemplary embodiment of the present invention, a location information device 22-26 is preferably affixed to infrastructure 20. The location information device of the present invention, i.e., a machine-readable coded identification item, may be a bar code 22, an information button 24, an RFID tag 26, some combination of these, or any other device which is capable of storing location data. The information stored on location information device 22-26 may be any information sufficient to uniquely identify the geographic location of location information device 22-26.

For example, information buttons (or “infobuttons”) are electronic devices which can store up to approximately 2K of data and which can be read using a contact reading device, which device is placed in contact with the information button to perform the reading function. Information buttons are available from, e.g., Dallas Semiconductor, and are described more fully at www.ibutton.com. Similar functionality may be provided, in accordance with the present invention, using bar codes and/or RFID tags.

In accordance with the present invention, information buttons may preferably be used to store useful information concerning location of the button in order to allow a mobile device 30, which may include a processor coupled to an information button reader as described in further detail hereinafter, to ascertain the present location of the device. Bar codes can also be used to encode location information into a format which can be read by a bar code scanner. RFID tags may encapsulate this information in such manner that an RFID reader device may extract the location information.

A wide variety of information may be stored by location information device 22-26 in accordance with various embodiments of the present invention. For example, these devices may store location information, which information can be used to ascertain the current location of the mobile device. The location may be a localized location, such as a position in a single room, or a location based on some larger scale, such as position within a shopping mall or geographic location in a city or state. Regardless, one of ordinary skill in the art would understand that the present invention applies to varying scopes with respect to location information. Furthermore, the location information may be stored in numerous ways, such as with a unique identifier which indirectly may provide the location of location information device 22-26, or a more direct manner, such as address information, coordinates, latitude and longitude values, two- or three-dimensional coordinate values for a space within a particular building or room, etc.

Such additional information may preferably be stored on location information device 22-26 as would be advantageous within the context of the implementation of the system and method of the present invention. For example, it may be beneficial to store location-based information which can be read by a mobile reader device without use of the wireless network or in conjunction with the wireless network. Such embodiments are further described hereinafter.

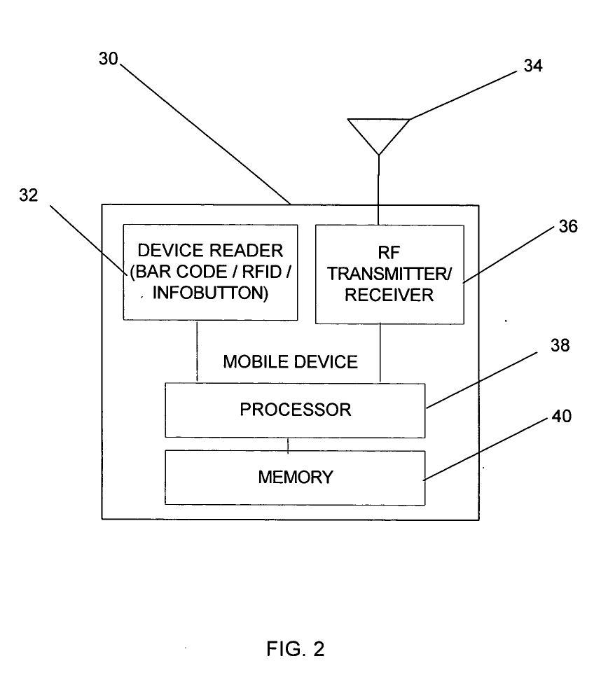

Referring now to FIG. 2, an exemplary embodiment of a mobile device 30 of the present invention is shown. Mobile device 30 preferably includes a processor 38, which may be a microcontroller, microprocessor, digital signal processor, application-specific integrated circuit (ASIC) or any other control circuit which would be known to one of ordinary skill in the art. Processor 38 may communicate with a memory 40, which may be random access memory (RAM), read-only memory (ROM), or any other type of memory which is known to one of ordinary skill in the art. Processor 38 may also communicate with RF radio 36, which is equipped with an antenna 34 for sending and/or receiving data over the wireless network. RF radio 36 is configured to communicate in accordance with the selected type of wireless area network. Depending upon the selected type of wireless network, RF radio 36 may be a GPRS radio, 802.11b radio, Bluetooth radio, or any other device capable of transmitting and receiving data over the selected type of wireless network.

Mobile device 30 is also preferably configured with a device reader 32. Device reader 32 may be one or more of a bar code scanner, RFID tag reader or Infobutton reader. Alternatively, Device reader 32 may be any apparatus which is capable of reading the location information stored on the location information devices 22-26 of FIG. 1, or any other location information device used in accordance with the present invention.

Mobile device 30 may also preferably be configured with a display (not shown). The display may be a standard LCD display suitable for displaying information retrieved over the wireless network.

The mobile device 30 may also preferably be configured with input apparatus to receive input from the mobile device user (not shown). The input apparatus may be touch-screen functionality in the LCD display, buttons, a text or numeric keypad, a pointer device, pen-based, or any other means for receiving user input by the mobile device 30 as would be known to one of ordinary skill in the art.

It is further noted that while mobile device 30 may preferably be a single integrated standalone unit, it need not be. Mobile device 30 may be composed of a traditional laptop computer, personal digital assistant (PDA), handheld computer, cellular phone, or similar computing device which is configured to communication over a wireless network, used in combination with an attached reading device capable of reading information from location information devices 22-26, such as a handheld barcode scanner or RFID reader accessory.

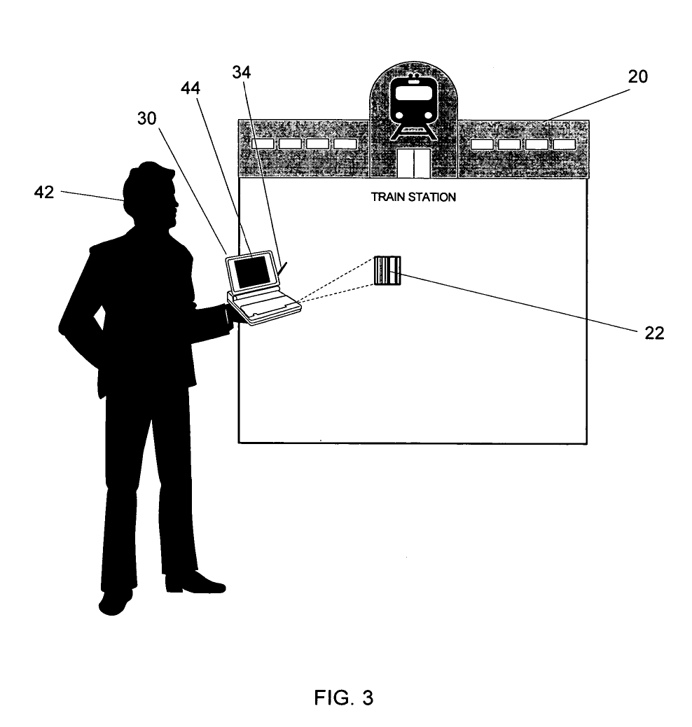

Referring now to FIG. 3, in one exemplary embodiment of the present invention, the system and method described may be implemented to provide content enriched information regarding public transportation systems. Location devices such as bar code 22 may preferably be affixed on infrastructure 20, in this example, a train station. Additional barcodes 22 may be placed in surrounding areas on bus stop shelters, mailboxes, parking meters, restaurant storefronts, business storefronts, and any other location. Bar code 22 is preferably encoded with unique information regarding its location. In operation, a train commuter 42 utilizing mobile device 30 may scan barcode 22 to enable the mobile device 20 to determine its location based on information read from barcode 22. Alternatively, the mobile device 30 may scan the barcode 22 and transmit the scanned information over the wireless network via a wireless radio (as described in connection with FIG. 2) and utilizing antenna 34. Then a server, such as server 12 or other computing device which is coupled to the wireless network, can receive the transmitted information scanned from barcode 22 and determine the location of mobile device 30 using the information, possible by accessing a database such as database 18.

Using the known location of the mobile device 30, the device may then preferably receive data via the wireless network which is specifically tailored to the location. The information may include schedule information for train station 20, real-time reports regarding rail conditions, delays, and service outages, fare information tied to the particular train station, etc. The display 44 of mobile device 30 may then display this information for the user. The user may interact using an input means to select additional or different information, as desired.

Additionally, the location information device—in this case barcode 22—may also be used to store information locally in addition to location information. For example, barcode 22 may store static information locally, such as schedule information, fare information, train system maps, etc. Such information may be read using mobile device 30 and thereafter provided to train commuter 42 via display 44.

Such functionality may provide several benefits. First, the information can be provided immediately to the user, with no waiting time for transmission of data over the wireless network. Additionally, if only such basic information is required, wireless network access may be avoided, thus prolonging battery life for the mobile device 30, conserving wireless network bandwidth for other users, and potentially alleviating service costs for wireless network access. Further, in the event of a wireless network outage or weak signal in the vicinity, train commuter 42 may still access the information sought.

In another exemplary embodiment of the present invention, the barcodes and other location devices may also store location-based content and advertising. For example, barcode 22 of FIG. 3 may also store advertising information relating to stores and restaurants in the vicinity of train station 20. This information may be provided to train commuter 42 via display 44. Additionally, or in the alternative, similar location-specific advertising information may be provided via the wireless network, and displayed to the user in a similar manner. In this way, the system and method of the present invention can be used to provide more effective, targeted advertising to a mobile device user based on the present location of the user.

In yet another exemplary embodiment of the present invention, a content-enriched wireless network may be implemented in a museum. In such an environment, it may be practicable and preferable to implement the present invention using a wireless local area network, such as an 802.11 network. Museum visitors may be provided with a mobile device 30 of FIG. 2. Location information devices 22-26 may be affixed throughout the museum, for example, at each exhibit location. As a user traverses the museum, the user may read information devices 22-26 using the mobile device 30 to obtain enriched content concerning the selected exhibit. The enriched content may be read directly from the location information devices, may be received over the wireless network based on a location read from the location information devices, or in some combination thereof.

In yet another exemplary embodiment of the present invention, a content-enriched wireless network may be implemented in a shopping mall. Shoppers may be provided with a mobile device 30 of FIG. 2. Location information devices 22-26 may be affixed throughout the shopping mall, for example, at each store or on mall directory displays. As a shopping navigates the shopping mall, the shopper may use the mobile device to read information devices 22-26 and obtain content concerning the selected stores or locations. Content may include information about particular stores, including sales and special promotional events. The content may also include directory information including maps and other information which may aid the shopper in navigating the shopping mall.

In still another exemplary embodiment of the present invention, content-enriched wireless network functionality may be implemented at public transportation terminals, such as train stations. The location information devices may be used to store, for example, train schedule and fare information. The information may be location-based custom information, such as fares from the particular location to some destination, schedule information at the particular station location, etc.

While there have been described what are believed to be the preferred embodiments of the present invention, those skilled in the art will recognize that other and further changes may be made thereto without departing from the spirit of the invention, and it is intended to claim all such changes and embodiments as fall within the true scope of the invention.

1. A method for providing location-based information over a wireless network, comprising:
providing at a geographic location a machine-readable coded identification item, said item providing data for uniquely identifying said geographic location;
providing a first database correlating said data to said geographic location;
providing a second database having information correlated to said geographic location;
reading said identification item with a portable reader to obtain said identification data;
using said first database to ascertain said geographic location; and
using said second database to retrieve information correlated to said geographic location.

2. A method as specified in claim 1, wherein said identification item is a bar code label.

3. A method as specified in claim 1, wherein said identification item is an RFID tag.

4. A method as specified in claim 1, wherein said identification item is an information button.

5. A method as specified in claim 1 wherein providing said second database includes providing a map.

6. A method as specified in claim 1 wherein providing said second database includes providing information regarding businesses located in the vicinity of said geographic location.

7. A method as specified in claim 1 wherein said information correlated to said geographic location is retrieved via a wireless network.

8. A system for providing location-based information, comprising:
a wireless network;
a machine-readable coded identification item, said item storing data related to the location of said machine-readable coded identification item; and
a mobile device, which mobile device includes at least a processor, a memory, a wireless radio configured to communicate on said wireless network, and a reader capable of reading data from said machine-readable coded identification item;
wherein said mobile device is configured to read said data from said machine-readable coded identification item and transmit said data over said wireless network, and further to receive from said wireless network information relating to said location of said machine-readable coded identification item.

9. The system of claim 8 wherein the machine-readable coded identification item is a bar code.

10. The system of claim 8 wherein the machine-readable coded identification item is an RFID tag.

11. The system of claim 8 wherein the machine-readable coded identification item is an information button.

12. A method for providing location-based information over a wireless network, comprising:
providing at a geographic location a machine-readable coded identification item, said item providing data for uniquely identifying said geographic location; and
reading said identification item with a portable reader to obtain information regarding said geographic location.

13. A system for providing location-based information, comprising:
a wireless network;
a machine-readable coded identification item, said item storing data related to the location of said machine-readable coded identification item; and
a mobile device, which mobile device includes at least a processor, a memory, a wireless radio configured to communicate on said wireless network, and a reader capable of reading data from said machine-readable coded identification item;
wherein said mobile device is configured to read said data from said machine-readable coded identification item to obtain information regarding the location of said mobile device.

14. A method for providing location-based information over a wireless network, comprising:
providing at a geographic location a machine-readable coded identification item, said item providing data for uniquely identifying said geographic location;
providing a database correlating said data to information relating to said geographic location;
reading said identification item with a portable reader to obtain said identification data; and
providing said information relating to said geographic location to said portable reader.
